(19) United States
(12) Patent Application Publication
(10) Pub. No.: US 2025/0329954 A1
(43) Pub. Date: Oct. 23, 2025

(54) CONNECTOR

(71) Applicant: Murata Manufacturing Co., Ltd., Kyoto-fu (JP)

(72) Inventors: Eisho MURAKAMI, Nagaokakyo-shi (JP); Daisuke OKUBO, Nagaokakyo-shi (JP); Kazuhisa YAMAKI, Nagaokakyo-shi (JP); Toshimichi OIWANE, Nagaokakyo-shi (JP)

(73) Assignee: Murata Manufacturing Co., Ltd., Kyoto-fu (JP)

(21) Appl. No.: 19/259,402

(22) Filed: Jul. 3, 2025

Related U.S. Application Data
(63) Continuation of application No. PCT/JP2023/045693, filed on Dec. 20, 2023.

(30) Foreign Application Priority Data
Jan. 5, 2023 (JP) 2023-000446

(51) Int. Cl. H01R 13/405; H01R 12/71; H01R 13/05

(52) U.S. Cl. CPC H01R 13/405; H01R 12/716; H01R 13/055

(57) ABSTRACT

A connector includes a resin body member and an external connection terminal. The external connection terminal includes a first main surface and a second main surface parallel to each other and includes a first side surface and a second side surface each connecting the first main surface and the second main surface. The first side surface includes a first planar part and a first recess adjacent to the first planar part. The resin body member supports the external connection terminal by being in contact with at least a portion of the second main surface, at least a portion of the first planar part, and the first recess.

### CROSS-REFERENCE TO RELATED APPLICATIONS

This application claims benefit of priority to International Patent Application No. PCT/JP2023/045693, filed Dec. 20, 2023, and to Japanese Patent Application No. 2023-000446, filed Jan. 5, 2023, the entire contents of each are incorporated herein by reference.

### BACKGROUND

### Technical Field

The present disclosure relates to a connector.

### Background Art

As an disclosure related to a known connector, for example, an electrical connector described in Japanese Patent No. 5458042 has been known. The electrical connector includes a housing and a terminal. The housing is produced by using an electrically insulating material. The terminal is formed by bending a metal strip. The terminal is held by the housing.

### SUMMARY

In the field of the electrical connector described in Japanese Patent No. 5458042, there is a demand for suppressing a terminal from coming off a housing.

Thus, the present disclosure provides a connector in which an external connection terminal can be suppressed from coming off a resin body member.

A connector according to an embodiment of the present disclosure includes a resin body member; and an external connection terminal. The external connection terminal includes a first main surface and a second main surface parallel to each other and includes a first side surface and a second side surface each connecting the first main surface and the second main surface. The first side surface includes a first planar part and a first recess adjacent to the first planar part, an area of the first planar part is larger than an area of the first recess, and the resin body member supports the external connection terminal by being in contact with at least a portion of the second main surface, at least a portion of the first planar part, and the first recess.

The positional relationships of the members in the present description are defined below. First to third members are constituents of a connector set. In the present description, the first member and the second member arranged along a front-back axis are in the following state. When the first member and the second member are viewed in a perpendicular direction along the front-back axis, the first member and the second member are in a state of being both disposed on any straight line indicating a front-back direction. In the present description, the first member and the second member arranged along the front-back axis when viewed in a downward direction are in the following state. When the first member and the second member are viewed in the downward direction, the first member and the second member are both disposed on any straight line indicating the front-back direction. In this case, when the first member and the second member are viewed in a leftward direction that is different from the downward direction, any one of the first member and the second member is not necessarily disposed on the selected straight line indicating the front-back direction. Note that the first member and the second member may be in contact with each other. The first member and the second member may be separated from each other. The third member may exist between the first member and the second member. This definition also applies to directions other than the front-back direction.

In the present description, a state where the first member is disposed on the second member refers to the following state. At least a portion of the first member is positioned directly above the second member. Thus, the first member overlaps the second member when viewed in the downward direction. This definition also applies to directions other than the downward direction.

In the present description, a state where the first member is disposed above the second member includes a case where at least a portion of the first member is positioned directly above the second member and a case where the first member is not positioned directly above the second member but is positioned diagonally above the second member. In this case, the first member does not necessarily overlap the second member when viewed in the downward direction. Diagonally above is, for example, upper left or upper right. This definition also applies to directions other than an up-down direction.

In the present description, except where specifically noted, portions of the first member will be defined as follows. A front portion of the first member means a front half of the first member. A back portion of the first member means a back half of the first member. A left portion of the first member means a left half of the first member. A right portion of the first member means a right half of the first member. An upper portion of the first member means an upper half of the first member. A lower portion of the first member means a lower half of the first member. A front end of the first member means an end of the first member in a forward direction. A back end of the first member means an end of the first member in a backward direction. A left end of the first member means an end of the first member in the leftward direction. A right end of the first member means an end of the first member in a rightward direction. An upper end of the first member means an end of the first member in an upward direction. A lower end of the first member means an end of the first member in the downward direction. A front end portion of the first member means the front end of the first member and the vicinity of the front end. A back end portion of the first member means the back end of the first member and the vicinity of the back end. A left end portion of the first member means the left end of the first member and the vicinity of the left end. A right end portion of the first member means the right end of the first member and the vicinity of the right end. An upper end portion of the first member means the upper end of the first member and the vicinity of the upper end. A lower end portion of the first member means the lower end of the first member and the vicinity of the lower end.

When any two members given in the present description are defined as the first member and the second member, the relationship between the two selected members means as follows. In the present description, a state where the first member is supported by the second member includes a case where the first member is attached to the second member so as not to move relative to the second member (that is, the first member is fixed to the second member) and a case where the first member is attached to the second member so as to move relative to the second member. In addition, the state where the first member is supported by the second member includes both a case where the first member is directly attached to the second member and a case where the first member is attached to the second member with the third member interposed therebetween.

In the present description, a state where the first member is held by the second member includes the case where the first member is attached to the second member so as not to move relative to the second member (that is, the first member is fixed to the second member) but does not include the case where the first member is attached to the second member so as to move relative to the second member. In addition, the state where the first member is held by the second member includes both the case where the first member is directly attached to the second member and the case where the first member is attached to the second member with the third member interposed therebetween.

In the present description, the phrase “the first member and the second member are electrically connected to each other” means that there is conduction of electricity between the first member and the second member. Thus, the first member and the second member may be in contact with each other, or the first member and the second member are not necessarily in contact with each other. In the case where the first member and the second member are not in contact with each other, the third member having electrical conductivity is disposed between the first member and the second member.

With the connector according to the present disclosure, the external connection terminal can be suppressed from coming off the resin body member.

### BRIEF DESCRIPTION OF THE DRAWINGS

FIG. 1 is a perspective view of a connector set;

FIG. 2 is a perspective view of a first connector;

FIG. 3 is a perspective view of ground terminals, a contact terminal, and signal terminals of the first connector;

FIG. 4 is an external perspective view of the signal terminal;

FIG. 5 is a sectional view of the signal terminal;

FIG. 6 is a perspective view of a second connector;

FIG. 7 is a perspective view of ground terminals, contact terminals, and signal terminals of the second connector;

FIG. 8 is an external perspective view of a signal terminal according to a first modification example;

FIG. 9 is an external perspective view of a signal terminal according to a second modification example;

FIG. 10 is an external perspective view of a signal terminal according to a third modification example; and

FIG. 11 is an external perspective view of a signal terminal according to a fourth modification example.

### DETAILED DESCRIPTION

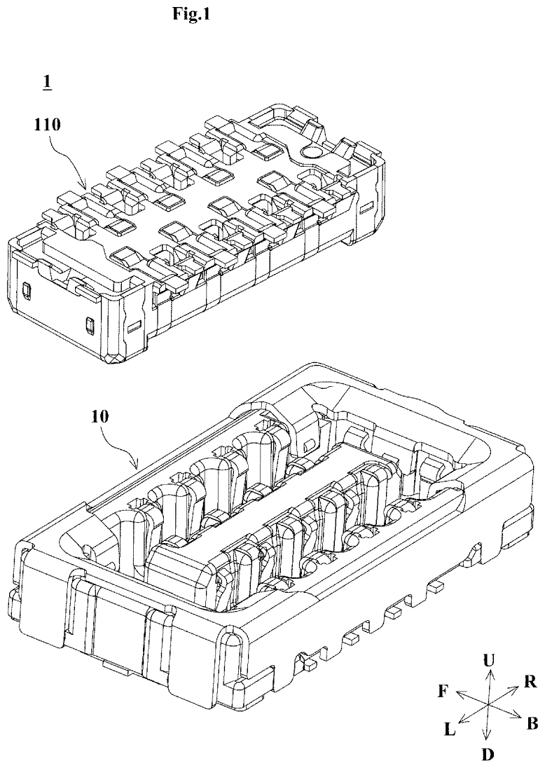

Hereinafter, a connector set 1 including a first connector 10 according to an embodiment of the present disclosure will be described. FIG. 1 is a perspective view of the connector set 1.

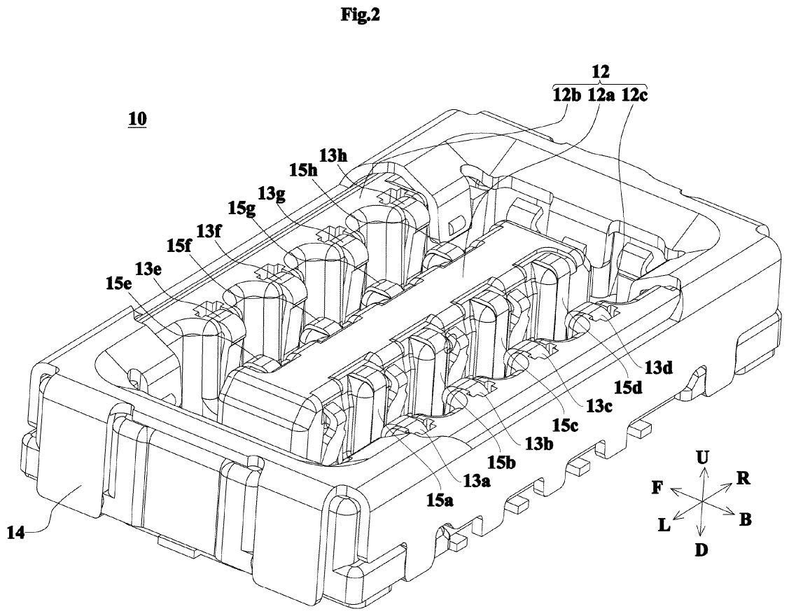

In the following description, as FIG. 1 illustrates, a direction from a second connector 110 toward the first connector 10 is defined as the downward direction. In addition, a direction where signal terminals 15a to 15d (refer to FIG. 2) are arranged in this order in the first connector 10 is defined as the rightward direction. A left-right axis is orthogonal to an up-down axis. In addition, an axis orthogonal to the left-right axis and to the up-down axis is defined as the front-back axis. However, the up-down axis, the left-right axis, and the front-back axis in the present description are the directions defined for convenience of description and do not necessarily agree with the up-down axis, the left-right axis, and the front-back axis of the connector set 1 in use. In each of the drawings, the upward direction and the downward direction may be interchanged, the leftward direction and the rightward direction may be interchanged, and the frontward direction and the backward direction may be interchanged.

The connector set 1 is used for connecting two circuit boards, for example. The connector set 1 includes the first connector 10 and the second connector 110. When the first connector 10 and the second connector 110 are connected to each other, the second connector 110 is positioned on the first connector 10.

### [Structure of First Connector]

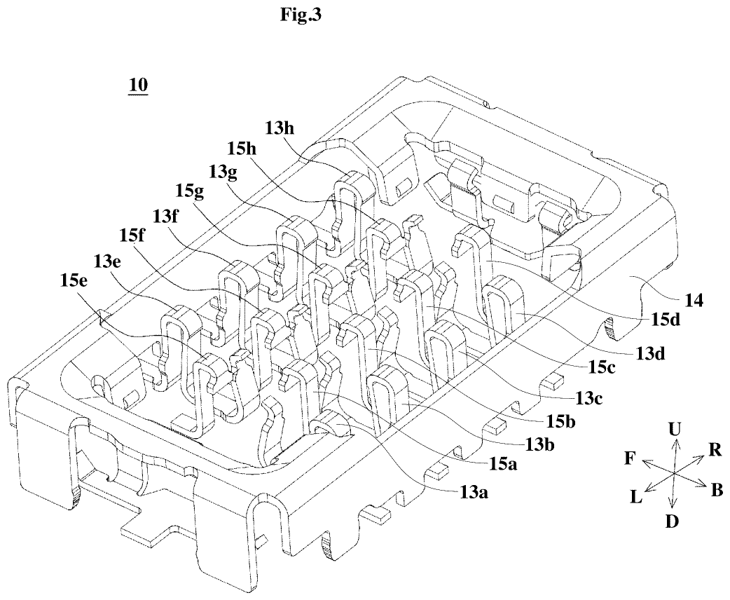

Next, the structure of the first connector 10 will be described. FIG. 2 is a perspective view of the first connector 10. FIG. 3 is a perspective view of ground terminals 13a to 13h, a contact terminal 14, and signal terminals 15a to 15h of the first connector 10.

As FIGS. 2 and 3 illustrate, the first connector 10 includes a resin body member 12, the ground terminals 13a to 13h, the contact terminal 14, and the signal terminals 15a to 15h (external connection terminal).

As FIG. 2 illustrates, the resin body member 12 includes a protrusion 12a, a frame part 12b, and a coupling part 12c. The protrusion 12a extends along the left-right axis when viewed in the downward direction. In more detail, the protrusion 12a has a rectangular parallelepiped shape. The protrusion 12a has two long sides extending along the left-right axis and two short sides extending along the front-back axis when viewed in the downward direction.

The frame part 12b has an annular shape surrounding the periphery of the protrusion 12a when viewed in the downward direction. The frame part 12b has a front side and a back side extending along the left-right axis and a left side and a right side extending along the front-back axis. The protrusion 12a is positioned in a region surrounded by the frame part 12b when viewed in the downward direction. The protrusion 12a is not in contact with the frame part 12b.

When viewed in the downward direction, the coupling part 12c is positioned between the protrusion 12a and the frame part 12b and couples the protrusion 12a and the frame part 12b. In the present embodiment, the coupling part 12c couples a lower portion of the protrusion 12a and a lower portion of the frame part 12b. The material of the resin body member 12 is an insulating material. The material of the resin body member 12 is, for example, resin.

The ground terminals 13a to 13h are connected to a ground potential. The ground terminals 13a to 13h are supported by the resin body member 12. In more detail, a portion of each of the ground terminals 13a to 13d is embedded in the back side of the frame part 12b. Thus, the ground terminals 13a to 13d are supported by the frame part 12b so as to be arranged along the left-right axis in a region behind the protrusion 12a. The ground terminals 13a to 13d are arranged in a row in this order from left to right. A portion of each of the ground terminals 13e to 13h is embedded in the front side of the frame part 12b. The ground terminals 13e to 13h are supported by the frame part 12b so as to be arranged along the left-right axis in a region in front of the protrusion 12a. The ground terminals 13e to 13h are positioned in front of the ground terminals 13a to 13d. The ground terminals 13e to 13h are arranged in a row in this order from left to right. The ground terminals 13a to 13h are each produced by subjecting bending to a rod-shaped metal member. The material of the ground terminals 13a to 13h is, for example, a copper-based material such as phosphor bronze.

The contact terminal 14 is connected to a ground potential. The contact terminal 14 is supported by the resin body member 12. Specifically, the contact terminal 14 is supported by the left side, the right side, the front side, and the back side of the frame part 12b. Thus, the contact terminal 14 has an annular shape surrounding the periphery of the protrusion 12a when viewed in the downward direction. The contact terminal 14 has a front side and a back side extending along the left-right axis and a left side and a right side extending along the front-back axis.

A radio-frequency signal is input to and output from the signal terminals 15a to 15 h. The signal terminals 15a to 15h are supported by the resin body member 12. In more detail, a portion of each of the signal terminals 15a to 15d is embedded in a back portion of the protrusion 12a. Thus, the signal terminals 15a to 15d are supported by the protrusion 12a so as to be arranged along the left-right axis in a back region of the protrusion 12a. The signal terminals 15a to 15d are arranged in a row in this order from left to right. Thus, the ground terminal 13a, the signal terminal 15a, the ground terminal 13b, the signal terminal 15b, the ground terminal 13c, the signal terminal 15c, the ground terminal 13d, and the signal terminal 15d are arranged in this order from left to right.

A portion of each of the signal terminals 15e to 15h is embedded in a front portion of the protrusion 12a. The signal terminals 15e to 15h are supported by the protrusion 12a so as to be arranged along the left-right axis in a region in front of the protrusion 12a. The signal terminals 15e to 15h are positioned in front of the signal terminals 15a to 15d. The signal terminals 15e to 15h are arranged in a row in this order from left to right. Thus, the signal terminal 15e, the ground terminal 13e, the signal terminal 15f, the ground terminal 13f, the signal terminal 15g, the ground terminal 13g, the signal terminal 15h, and the ground terminal 13h are arranged in this order from left to right. Thus, the signal terminals 15e to 15h are positioned in front of the ground terminals 13a to 13d. The ground terminals 13e to 13h are positioned in front of the signal terminals 15a to 15d. The signal terminals 15a to 15h are each produced by subjecting bending to a rod-shaped metal member. The material of the signal terminals 15a to 15h is, for example, a copper-based material such as phosphor bronze.

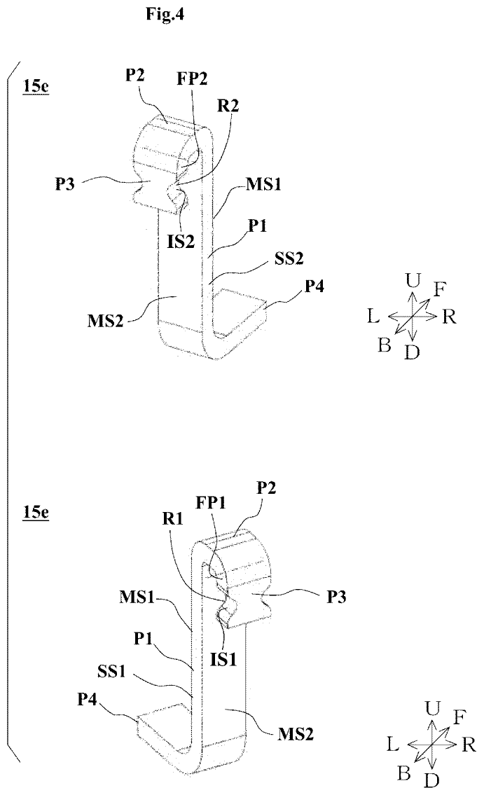

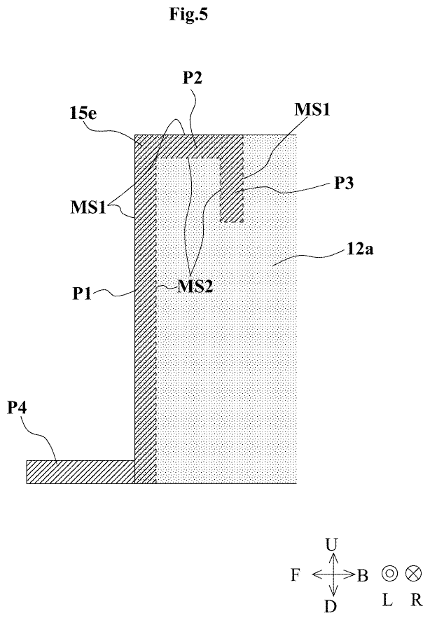

Here, the structure of each of the signal terminals 15a to 15h is described in a more detail by citing the signal terminal 15e as an example. FIG. 4 is an external perspective view of the signal terminal 15e. FIG. 5 is a sectional view of the signal terminal 15e.

The signal terminal 15e (external connection terminal) includes a first part P1, a second part P2, a third part P3, and a fourth part P4. The first part P1 extends along the up-down axis. The second part P2 extends in the backward direction from an upper end portion of the first part P1. The third part P3 extends in the downward direction from a back end portion of the second part P2. The fourth part P4 extends in the frontward direction from a lower end portion of the first part P1. The length of the first part P1 in the up-down axis is greater than the length of the third part P3 in the up-down axis.

In addition, the signal terminal 15e (external connection terminal) includes a first main surface MS1 and a second main surface MS2 parallel to each other and includes a first side surface SS1 and a second side surface SS2 each connecting the first main surface MS1 and the second main surface MS2. The first main surface MS1 is a front main surface of the first part P1, an upper main surface of the second part P2, a back main surface of the third part P3, and an upper main surface of the fourth part P4. The second main surface MS2 is a back main surface of the first part P1, a lower main surface of the second part P2, a front main surface of the third part P3, and a lower main surface of the fourth part P4. The first side surface SS1 is a left surface of the signal terminal 15e. The second side surface SS2 is a right surface of the signal terminal 15e.

The first side surface SS1 includes a first planar part FP1 and a first recess R1. The first planar part FP1 is a flat surface. The first planar part FP1 is positioned in the first part P1, the second part P2, and the third part P3. The first recess R1 is adjacent to the first planar part FP1. In the present embodiment, the first recess R1 is positioned in the third part P3. The first recess R1 is recessed in the rightward direction relative to the first planar part FP1. In the present embodiment, the first recess R1 is a cutout. Thus, the first recess R1 has a U shape when viewed in the downward direction. The first recess R1 is provided with a first inner peripheral surface IS1 in contact with the first main surface MS1 and the second main surface MS2. The area of the first planar part FP1 is larger than the area of the first recess R1. More precisely, the area of the first planar part FP1 is larger than the area of the first inner peripheral surface IS1.

The second side surface SS2 includes a second planar part FP2 and a second recess R2. The second planar part FP2 is a flat surface. The second planar part FP2 is positioned in the first part P1, the second part P2, and the third part P3. The second recess R2 is adjacent to the second planar part FP2. In the present embodiment, the second recess R2 is positioned in the third part P3. The second recess R2 is recessed in the leftward direction relative to the second planar part FP2. In the present embodiment, the second recess R2 is a cutout. Thus, the second recess R2 has a U shape when viewed in the downward direction. The second recess R2 is provided with a second inner peripheral surface IS2 in contact with the first main surface MS1 and the second main surface MS2. The area of the second planar part FP2 is larger than the area of the second recess R2. More precisely, the area of the second planar part FP2 is larger than the area of the second inner peripheral surface IS2.

The resin body member 12 supports the signal terminal 15e (external connection terminal) by being in contact with at least a portion of the second main surface MS2, at least a portion of the first planar part FP1, and the first recess R1. In the present embodiment, the second main surface MS2 of the first part P1, the second part P2, and the third part P3; the first main surface MS1 of the third part P3; and the first side surface SS1 and the second side surface SS2 of the first part P1, the second part P2, and the third part P3 are in contact with the resin body member 12. On the other hand, the first main surface MS1 of the first part P1 and the second part P2 and the entire fourth part P4 are exposed from the resin body member 12.

In the first connector 10 described above, the first connector 10 is mounted on a first circuit board (not illustrated) so that a lower surface of the resin body member 12 faces the first circuit board. Specifically, a portion of each of the ground terminals 13a to 13h, a portion of the contact terminal 14, and a portion of each of the signal terminals 15a to 15h are exposed from a bottom surface of the resin body member 12. Solder is thus applied to each of the portions. Thus, the ground terminals 13a to 13 h, the contact terminal 14, and the signal terminals 15a to 15h are connected to respective electrodes of the first circuit board.

In the first connector 10, the fourth part P4 extends in the frontward direction from the lower end portion of the first part P1. Thus, the fourth part P4 is positioned opposite from the third part P3 when viewed from the first part P1. The fourth part P4 is subjected to application of solder when the first connector 10 is mounted. On the other hand, the first part P1 is held by the resin body member 12. Such “separation” between the first part P1 and the fourth part P4 in an above-described way facilitates fixation of the first part P1 to the resin body member 12 and fixation of the fourth part P4 to the first circuit board.

### [Structure of Second Connector]

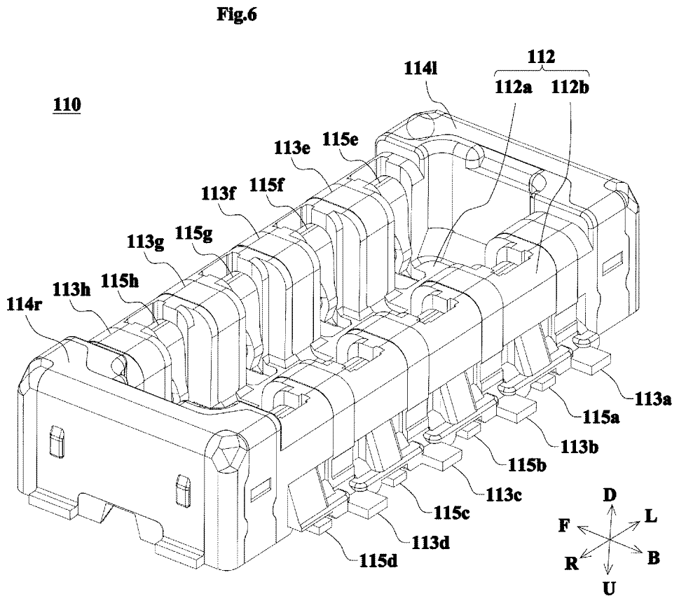

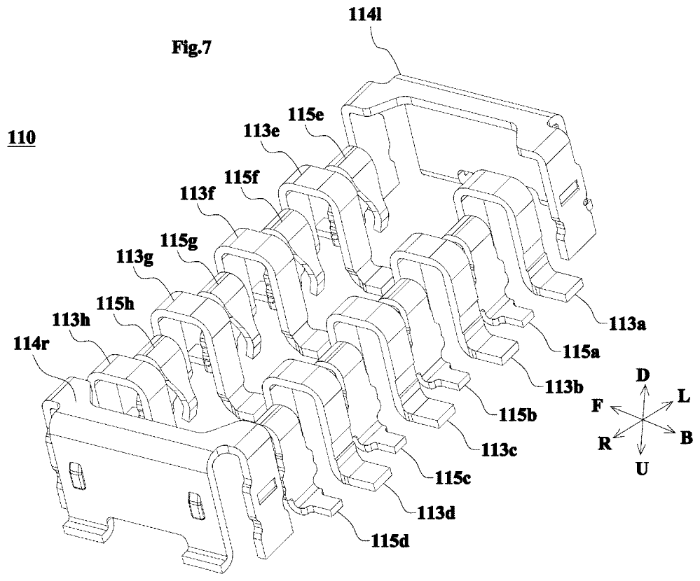

Next, the structure of the second connector 110 will be described. FIG. 6 is a perspective view of the second connector 110. FIG. 7 is a perspective view of ground terminals 113a to 113h, contact terminals 114l, 114r, and signal terminals 115a to 115h of the second connector 110.

As FIG. 6 illustrates, the second connector 110 includes a resin body member 112, the ground terminals 113a to 113h, the contact terminals 114l, 114r, and the signal terminals 115a to 115h.

The resin body member 112 includes a bottom surface part 112a and a frame part 112b. The frame part 112b has an annular shape when viewed in the upward direction. In more detail, the frame part 112b includes a rectangular outer edge and a rectangular inner edge when viewed in the upward direction. Each of the outer edge of the frame part 112b and the inner edge of the frame part 112b includes two long sides extending along the left-right axis and two short sides extending in the front-back direction when viewed in the upward direction. As FIG. 6 illustrates, the bottom surface part 112a covers the upper side of a region surrounded by the frame part 112b when viewed in the upward direction. The material of the resin body member 112 is an insulating material. The material of the resin body member 112 is, for example, resin.

A radio-frequency signal is input to and output from the ground terminals 113a to 113h. The ground terminals 113a to 113h are supported by the resin body member 112. In more detail, a portion of each of the ground terminals 113a to 113d is embedded in a back side of the frame part 112b. The ground terminals 113a to 113d are arranged in a row in this order from left to right. A portion of each of the ground terminals 113e to 113h is embedded in a front side of the frame part 112b. The ground terminals 113e to 113h are positioned in front of the ground terminals 113a to 113d. The ground terminals 113e to 113h are arranged in a row in this order from left to right. The ground terminals 113a to 113h are each produced by subjecting bending to a rod-shaped metal member. The material of the ground terminals 113a to 113h is, for example, a copper-based material such as phosphor bronze.

The contact terminals 114l, 114r are connected to a ground potential. The contact terminal 114l is supported by the resin body member 112. The contact terminal 114l is partially embedded in a left end portion of the front side of the frame part 112b, in a left end portion of the back side of the frame part 112b, and in a left side of the frame part 112b. The contact terminal 114l is produced by subjecting bending to a metal member. The material of the contact terminal 114l is, for example, a copper-based material such as phosphor bronze. Note that the structure of the contact terminal 114r is symmetrical to the structure of the contact terminal 114l, and the description thereof is thus omitted.

A radio-frequency signal is input to and output from the signal terminals 115a to 115h. The signal terminals 115a to 115h are supported by the resin body member 112. In more detail, a portion of each of the signal terminals 115a to 115d is embedded in the back side of the frame part 112b. The signal terminals 115a to 115d are arranged in a row in this order from left to right. Thus, the ground terminal 113a, the signal terminal 115a, the ground terminal 113b, the signal terminal 115b, the ground terminal 113c, the signal terminal 115c, the ground terminal 113d, and the signal terminal 115d are arranged in this order from left to right.

A portion of each of the signal terminals 115e to 115h is embedded in the front side of the frame part 112b. The signal terminals 115e to 115h are positioned in front of the signal terminals 115a to 115d. The signal terminals 115e to 115h are arranged in a row in this order from left to right. Thus, the signal terminal 115e, the ground terminal 113e, the signal terminal 115f, the ground terminal 113f, the signal terminal 115g, the ground terminal 113g, the signal terminal 115h, and the ground terminal 113h are arranged in this order from left to right. Thus, the signal terminals 115e to 115h are positioned in front of the ground terminals 113a to 113d. The ground terminals 113e to 113h are positioned in front of the signal terminals 115a to 115d. The signal terminals 115a to 115h are each produced by subjecting bending to a rod-shaped metal member. The material of the signal terminals 115a to 115h is, for example, a copper-based material such as phosphor bronze.

In the second connector 110 described above, the second connector 110 is mounted on a second circuit board (not illustrated) so that a lower surface of the resin body member 112 faces the circuit board. Specifically, a portion of each of the ground terminals 113a to 113h, a portion of each of the contact terminals 114l, 114r, and a portion of each of the signal terminals 115a to 115h are exposed from an upper surface of the resin body member 112. Solder is thus applied to each of the portions. Thus, the ground terminals 113a to 113h, the contact terminals 114l, 114r, and the signal terminals 115a to 115h are connected to respective electrodes of the second circuit board.

As FIG. 1 illustrates, the frame part 112b of the second connector 110 is inserted in the region surrounded by the frame part 12b of the first connector 10. At this point, the protrusion 12a of the first connector 10 is inserted in the region surrounded by the frame part 112b of the second connector 110. Thus, the ground terminals 13a to 13h are in contact with the ground terminals 113a to 113h, respectively. Respective portions of the contact terminal 14 are in contact with the contact terminals 114l, 114r. The signal terminals 15a to 15h are in contact with the signal terminals 115a to 115h, respectively.

In the first connector 10, the resin body member 12 supports the signal terminal 15e by being in contact with at least a portion of the second main surface MS2, at least a portion of the first planar part FP1, and the first recess R1. Thus, upon application of force on the signal terminal 15e, the first recess R1 is caught on the resin body member 12. As a result, the signal terminal 15e is suppressed from coming off the resin body member 12.

In the first connector 10, the isolation between radio-frequency signals transmitted through the signal terminals 15a to 15h is improved. Description will be given by citing the signal terminals 15a, 15e as an example. The ground terminal 13e is positioned in front of the signal terminal 15a. The ground terminal 13a is positioned behind the signal terminal 15e. Thus, the signal terminal 15a and the signal terminal 15e are not arranged along the front-back axis. Thus, the isolation between radio-frequency signals transmitted through the signal terminals 15a to 15h is improved.

In the first connector 10, the isolation between radio-frequency signals transmitted through the signal terminals 15a to 15h is improved also due to the following reason. Description will be given by citing the signal terminals 15a, 15e as an example. The signal terminals 15a, 15e each include the first recess R1. Thus, the facing area between the signal terminal 15a and the signal terminal 15e is reduced. The capacitance formed between the signal terminal 15a and the signal terminal 15e is reduced accordingly. As a result, the electromagnetic coupling between the signal terminal 15a and the signal terminal 15e is suppressed, and the isolation between radio-frequency signals transmitted through the signal terminals 15a to 15h is improved.

### First Modification Example

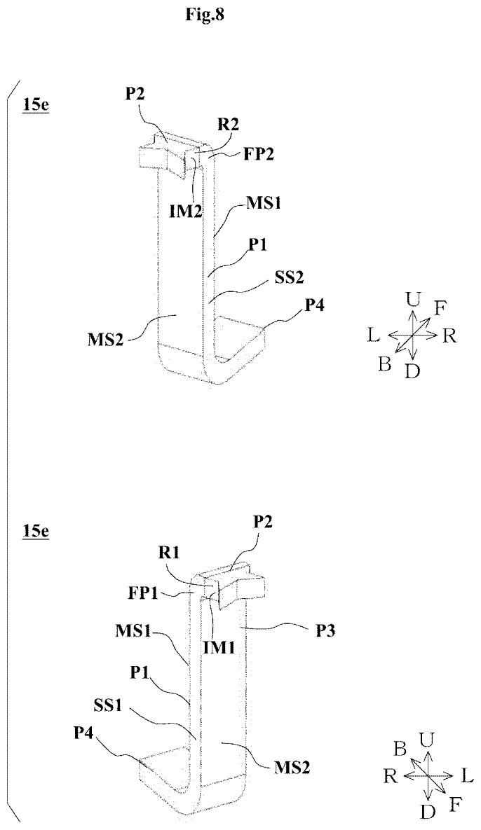

Hereinafter, a signal terminal 15e according to a first modification example will be described with reference to the drawings. FIG. 8 is an external perspective view of the signal terminal 15e according to the first modification example.

The signal terminal 15e according to the first modification example differs from the signal terminal 15e according to the embodiment in that the signal terminal 15e according to the first modification example does not include a third part P3. A first recess R1 and a second recess R2 are positioned in a second part P2. The other constituents of the signal terminal 15e according to the first modification example are the same as those of the signal terminal 15e according to the embodiment, and the description thereof is thus omitted.

### Second Modification Example

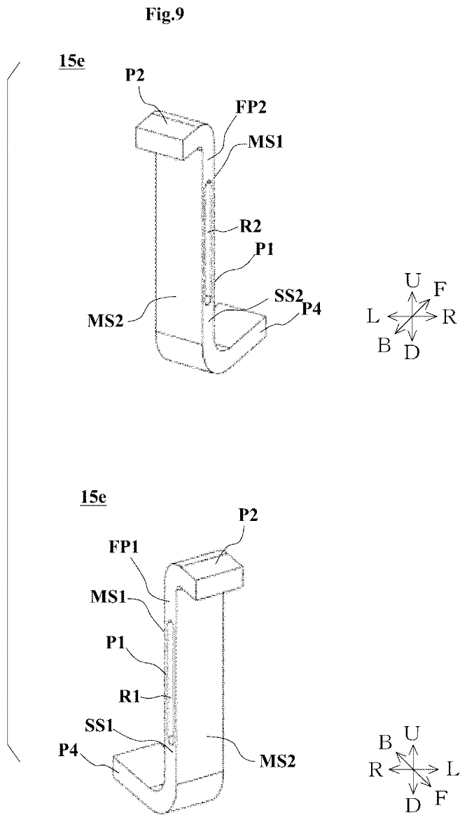

Hereinafter, a signal terminal 15e according to a second modification example will be described with reference to the drawings. FIG. 9 is an external perspective view of the signal terminal 15e according to the second modification example.

The signal terminal 15e according to the second modification example differs from the signal terminal 15e according to the embodiment in that the signal terminal 15e according to the second modification example does not include a third part P3. A first recess R1 and a second recess R2 are positioned in a first part P1. The first recess R1 and the second recess R2 each extend along the up-down axis when viewed in the leftward direction or the rightward direction. The first recess R1 and the second recess R2 are each a hole with a bottom. The other constituents of the signal terminal 15e according to the second modification example are the same as those of the signal terminal 15e according to the embodiment, and the description thereof is thus omitted.

### Third Modification Example

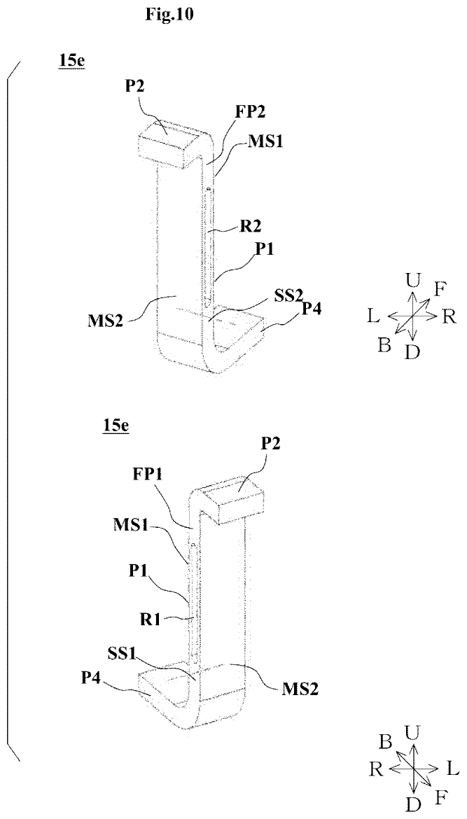

Hereinafter, a signal terminal 15e according to a third modification example will be described with reference to the drawings. FIG. 10 is an external perspective view of the signal terminal 15e according to the third modification example.

The signal terminal 15e according to the third modification example differs from the signal terminal 15e according to the second modification example in the shapes of a first recess R1 and a second recess R2. The first recess R1 and the second recess R2 are a through hole through which a first side surface SS1 and a second side surface SS2 are connected to each other. The other constituents of the signal terminal 15e according to the third modification example are the same as those of the signal terminal 15e according to the second modification example, and the description thereof is thus omitted.

### Fourth Modification Example

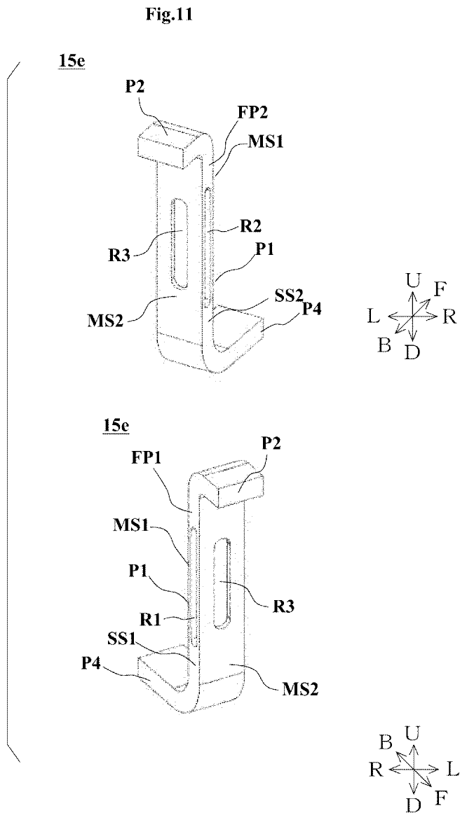

Hereinafter, a signal terminal 15e according to a fourth modification example will be described with reference to the drawings. FIG. 11 is an external perspective view of the signal terminal 15e according to the fourth modification example.

The signal terminal 15e according to the fourth modification example differs from the signal terminal 15e according to the second modification example in that the signal terminal 15e according to the fourth modification example includes a third recess R3. The third recess R3 is provided in a second main surface MS2 of a first part P1. The other constituents of the signal terminal 15e according to the fourth modification example are the same as those of the signal terminal 15e according to the second modification example, and the description thereof is thus omitted.

### Other Embodiments

The connector according to the present disclosure is not limited to the first connector 10 and can be changed without departing from the spirit of the present disclosure. Note that any combination among the structures of the signal terminals 15e of the embodiment and the first modification example to the fourth modification examples may be possible.

The present disclosure includes the following structure.

(1) A connector including a resin body member; and an external connection terminal. the external connection terminal includes a first main surface and a second main surface parallel to each other and includes a first side surface and a second side surface each connecting the first main surface and the second main surface. The first side surface includes a first planar part and a first recess adjacent to the first planar part, an area of the first planar part is larger than an area of the first recess, and the resin body member supports the external connection terminal by being in contact with at least a portion of the second main surface, at least a portion of the first planar part, and the first recess.

(2) The connector according to the item (1), in which the external connection terminal includes a first part and a second part, the first part extends along an up-down axis, the second part extends in a backward direction from an upper end portion of the first part, and the first main surface is a front main surface of the first part and an upper main surface of the second part. Also, the second main surface is a back main surface of the first part and a lower main surface of the second part, and the first recess is positioned in the first part or the second part.

(3) The connector according to the item (1), in which the external connection terminal includes a first part, a second part, and a third part, the first part extends along an up-down axis, the second part extends in a backward direction from an upper end portion of the first part, the third part extends in a downward direction from a back end portion of the second part, and a length of the first part in the up-down axis is greater than a length of the third part in the up-down axis. Also, the first main surface is a front main surface of the first part, an upper main surface of the second part, and a back main surface of the third part, the second main surface is a back main surface of the first part, a lower main surface of the second part, and a front main surface of the third part, and the first recess is positioned in the third part.

(4) The connector according to the item (2) or (3), in which the external connection terminal further includes a fourth part, and the fourth part extends in a frontward direction from a lower end portion of the first part.

(5) The connector according to the item (3), in which the first main surface of the first part is exposed from the resin body member.

(6) The connector according to any one of the items (1) to (5), in which the first recess is provided with a first inner peripheral surface in contact with the first main surface and the second main surface.

(7) The connector according to any one of the items (1) to (5), in which the first recess is a hole with a bottom.

(8) The connector according to any one of the items (1) to (5), in which the first recess is a through hole through which the first side surface and the second side surface are connected to each other.

What is claimed is:

1. A connector comprising:
a resin body member; and an external connection terminal, wherein
the external connection terminal includes a first main surface and a second main surface parallel to each other, a first side surface and a second side surface each connecting the first main surface and the second main surface, a first part that extends along an up-down axis, a second part that extends in a backward direction from an upper end portion of the first part, and a third part that extends in a downward direction from a back end portion of the second part,
the first main surface is a front main surface of the first part, an upper main surface of the second part, and a back main surface of the third part,
the second main surface is a back main surface of the first part, a lower main surface of the second part, and a front main surface of the third part,
the first side surface includes a first planar part and a first recess adjacent to the first planar part, the first recess being positioned in the third part,
an area of the first planar part is larger than an area of the first recess, and
the resin body member supports the external connection terminal by being in contact with at least a portion of the second main surface, and the third part including the first recess is entirely within the resin body member.

2. The connector according to claim 1, wherein
a length of the first part in the up-down axis is greater than a length of the third part in the up-down axis.

3. The connector according to claim 1, wherein
the external connection terminal further includes a fourth part, and
the fourth part extends in a frontward direction from a lower end portion of the first part.

4. The connector according to claim 1, wherein
the first main surface of the first part is exposed from the resin body member.

5. The connector according to claim 1, wherein
the first recess includes a first inner peripheral surface in contact with the first main surface and the second main surface.

6. The connector according to claim 2, wherein
the external connection terminal further includes a fourth part, and
the fourth part extends in a frontward direction from a lower end portion of the first part.

7. The connector according to claim 2, wherein
the first main surface of the first part is exposed from the resin body member.

8. The connector according to claim 3, wherein
the first main surface of the first part is exposed from the resin body member.

9. The connector according to claim 5, wherein
the first main surface of the first part is exposed from the resin body member.

10. The connector according to claim 6, wherein
the first main surface of the first part is exposed from the resin body member.

11. The connector according to claim 2, wherein
the first recess includes a first inner peripheral surface in contact with the first main surface and the second main surface.

12. The connector according to claim 3, wherein
the first recess includes a first inner peripheral surface in contact with the first main surface and the second main surface.

13. The connector according to claim 4, wherein
the first recess includes a first inner peripheral surface in contact with the first main surface and the second main surface.

14. The connector according to claim 6, wherein
the first recess includes a first inner peripheral surface in contact with the first main surface and the second main surface.

15. The connector according to claim 7, wherein
the first recess includes a first inner peripheral surface in contact with the first main surface and the second main surface.

16. The connector according to claim 8, wherein
the first recess includes a first inner peripheral surface in contact with the first main surface and the second main surface.

17. The connector according to claim 9, wherein
the first recess includes a first inner peripheral surface in contact with the first main surface and the second main surface.

18. The connector according to claim 10, wherein
the first recess includes a first inner peripheral surface in contact with the first main surface and the second main surface.
